(19) United States
(12) Patent Application Publication
(10) Pub. No.: US 2007/0245517 A1
(43) Pub. Date: Oct. 25, 2007

(54) Door check assembly

(75) Inventors: David M. Kiefer, Elkhart, IN (US); Mark L. Smith, Buchanan, MI (US); W. Glen Elijah, Goshen, IN (US)

Correspondence Address: BANNER & WITCOFF, LTD., 28 STATE STREET, 28th FLOOR, BOSTON, MA, 02109-9601, US

(73) Assignee: Atwood Mobile Products, Inc., Elkhart, IN (US)

(21) Appl. No.: 11/412,026

(22) Filed: Apr. 26, 2006

Related U.S. Application Data
(60) Provisional application No. 60/789,370, filed on Apr. 5, 2006.

(51) Int. Cl. E05F 3/10

(52) U.S. Cl. 16/52

(57) ABSTRACT

A door check assembly comprises a guide block and a one-piece or multi-piece elongate linkage having a range of travel back-and-forth through the guide block between a first position and a second position corresponding to open and closed positions, respectively, of a door assembly incorporating the door check assembly. A locking pin or other check-lock member is mounted in the guide block for movement between a locking position and an unlocking position. A check-lock actuator, e.g., hand-operated, electric, etc., is operatively connected via linkage directly or indirectly (i.e., alone or in combination with other link members) connecting the check-lock actuator to the check-lock member. The check-lock actuator is mounted in a door at a position, e.g., remote from the check-lock in order to be more convenient for the user. The check-lock actuator is operative via the linkage member to move the check-lock member between the locking position and the unlocking position. In the locking position the check-lock member, e.g., a locking pin, forms a positive locking engagement with the elongate linkage, which engagement is operative to prevent travel of the elongate linkage through the guide block and so, to prevent unintended closing of the door.

### CROSS REFERENCE

This application claims the benefit of provisional application Ser. No. 60/789,370, filed Apr. 5, 2006, the disclosure of which is expressly incorporated herein.

### FIELD OF THE INVENTION

The present invention generally relates to new and improved door check assemblies and to new and improved door assemblies incorporating such door check assemblies for releasably holding the door in an open position, and more particularly to door check assemblies suitable to be employed with an operating switch at a location remote from the door check.

### BACKGROUND OF THE INVENTION

Door checks have been used for many years in many kinds of doors, including recreational vehicle doors. Known door checks include, for example, simple door hooks and gas/spring props. Certain door checks have a link and a check body. The link is typically attached to a fixed member, such as the door frame or other structural body member of a vehicle or a door jamb, and the check body is attached to the door. When the door is opened, the check body moves with the door and slides or otherwise moves relative to the link. In some cases the link has a recess, often referred to as a detent or well, and the check body has a roller or bearing that rolls or slides over the link to the well. The door is temporarily held in an open position by the roller in the detent, which can be overcome by applying additional force to the door to move the roller out of the detent. In such designs the sweep of the link typically requires a large space in the door. This is especially a problem for thin doors, such as those used in recreational vehicles and trucks. To accommodate the sweep of the link, a large portion of material in such doors may have to be removed or relocated, potentially increasing the likelihood of problems with wind noise and water penetration. Moreover, the door check must be made large to accommodate the large change in the angle between the link and the door check as the door pivots from open to closed positions.

The door check taught in commonly owned U.S. Pat. No. 6,237,190 to Grumm et al., which is hereby incorporated by reference in its entirety for all purposes, is useful (as is the current invention) for thick or thin doors, such as doors in recreational vehicles, e.g., main doors, screen doors, baggage doors or other moveable door panels. The door check comprises a check body attached to the door and having an opening. The door check pivots with the door about a first axis. A main link is slidable through the door check opening as the door pivots. A second link is pivotably attached to the main link, and is pivotable about a second axis with respect to a rigid member. As the check body pivots about the first axis, the second link pivots about the second axis and the main link translates through the opening in the check body. The main link may have an irregular surface so that a large force may be required to move the door back from the open position to a closed position. The door check of U.S. Pat. No. 6,237,190 operates essentially passively, however, in that it does not provide a positive locking of the door in an open position. The force of a strong breeze against the door may in some cases be sufficient to overcome the resistance of the door check and close the door.

There is a need, therefore, for improved door check assemblies and for door assemblies incorporating such improved door check assemblies. In particular, there is a need for well designed door check assemblies which can hold a door in an open position even against substantial closing force, such as a strong breeze acting against the door. Accordingly, it is an object of the present invention to provide improved door check assemblies and door assemblies incorporating such improved door check assemblies. It is a further object of certain exemplary embodiments of the invention disclosed below, to provide improved door check assemblies that can function in a passive mode and, by operation of a switch, can instead function to positively lock the door in an open position until released. Additional objects and advantages of all or certain embodiments of the present invention will be apparent to those skilled in the art given the benefit of this disclosure.

### SUMMARY OF THE INVENTION

In accordance with a first aspect, a door check assembly comprises a guide block; a one-piece or multi-piece elongate linkage having a range of travel back-and-forth through the guide block between a first position and a second position corresponding to open and closed positions, respectively, of a door assembly incorporating the door check assembly; a locking pin or other check-lock member mounted in the guide block for movement between a locking position and an unlocking position; a selectable switch referred to here as an actuator, such as a hand-operated (e.g., finger operated) check-lock actuator or electric switch actuator, etc., for locking and unlocking the positive locking feature of the door check assembly; and a linkage member directly or indirectly (i.e., alone or in combination with other link members) connecting the check-lock actuator to the check-lock member. The check-lock actuator is remote from the check-lock in order to position it more conveniently for the user. It is remote in that it requires the linkage member to operably (i.e., in a force or motion transmitting manner) connect it to the check-lock member or guide block. The check-lock actuator is operative via the linkage member to move the check-lock member between the locking position and the unlocking position. In the locking position the check-lock member, e.g., a locking pin, forms a positive locking engagement with the elongate linkage, which engagement is operative to prevent travel of the elongate linkage through the guide block from the first position to the second position. In the unlocking position the check-lock does not prevent travel of the elongate linkage through the guide block from the first position to the second position.

In at least certain exemplary embodiments the check-lock member can be a lock-pin mounted for axial movement in the guide block in a direction substantially normal or perpendicular to the direction of travel of the elongate link through the guide block and check body. In certain exemplary embodiments the lock-pin or other check-lock member in the locking position, is received in a hole (e.g., a through-hole or blind socket) in the elongate link; in the unlocking position it is clear of the hole. The elongate linkage optionally may provide multiple holes to receive the check-lock member, thereby establishing corresponding multiple open positions for the door (e.g., half open, full open, etc.). The door check assembly is selectable, that is, it can be engaged or not engaged based on the preference of the user, by operation (or not) of the check-lock actuator. Thus, if the door of a door assembly incorporating the door check assembly is to be propped or held open by the door check assembly, the check-lock actuator is operated to engage the check-lock member to the elongate linkage.

In certain exemplary embodiments the check-lock member is spring biased toward the locking position, i.e., engaging the elongate linkage, at least when the actuator has been operated to be in the corresponding engaged position, such that the check-lock member establishes the aforesaid positive locking engagement with the elongate linkage as soon as the door has been opened sufficiently to bring the hole or other engagement feature of the elongate linkage into proper alignment with the check-lock member. Thus, the actuator is operated to engage the check-lock, and engagement does not occur until alignment is achieved by moving the door to a sufficiently open position. The actuator is again operated to release the check-lock member when the door is to be closed or further opened. In certain exemplary embodiments of the door check assembly, the positive locking feature of the door check can be put into a passive or inoperative mode, for example, the actuator in the unlocking position or condition can be operative to hold that position (e.g., by a detent, etc.) and, correspondingly, to hold the check-lock member in the unlocking position against a bias force of the check-lock member spring mounted in the guide block. For example, the actuator may have a detent, a catch or other feature to prevent or resist movement of the actuator to the locked position (and/or to the unlocked position). Other suitable designs for the check-lock member and for engaging the check-lock member to the elongate linkage will be apparent to those of ordinary skill in the art given the benefit of this disclosure.

In certain exemplary embodiments the door check assembly employs a check-lock actuator comprising a slide-bar switch, e.g., a finger operated switch having a vertically or horizontally sliding or rotationally operated switch member mounted to the door near the door latch, on the opposite side of the door from the check body. The switch can be operatively connected to the locking pin or other check-lock member, via a Bowden cable or other elongate flexible linkage extending from the slide-bar switch to the guide block and suitable to be fit into the narrow interior space of a door and to be curved as needed to traverse the width of the door past other door components. In certain exemplary embodiments the switch can be operatively connected to the check-lock member via a rod or other elongate rigid linkage member. Other suitable designs for the check-lock actuator and linkage to the check-lock member will be apparent to those of ordinary skill in the art given the benefit of this disclosure.

In at least certain exemplary embodiments the door check assembly further comprises a passive door check to hold the door automatically in an open position against at least moderate force, e.g., when opened to at least that position. The door check taught in commonly owned U.S. Pat. No. 6,237,190 to Grumm et al. is exemplary of such passive door check means. Thus, in certain exemplary embodiments of the door check assemblies disclosed here, at least one roller or other passive check member is mounted in a check body through which the elongate linkage travels as it travels back-and-forth through the guide block between the first and second positions mentioned above corresponding to open and closed positions, respectively, of a door assembly incorporating the door check assembly. The passive check member optionally is biased by a roller spring mounted in the check body into contact with the elongate linkage. In certain exemplary embodiments the elongate linkage has a raised portion or otherwise forms a detent to receive the passive check member. The passive check member is operative to roll or slide or otherwise pass into the detent, e.g., over such raised portion if any, as the elongate linkage travels through the check body toward the first position, i.e., the position corresponding to an open position of a door incorporating the door check assembly. The passive check member in the detent portion, being biased by the passive check member spring, is operative to provide resistance to the elongate linkage traveling back through the check body to the closed position. That is, force is required to lift the roller or other passive check member against the biasing force of the spring as it is lifted or otherwise moved out of the detent, e.g., by a ramped shoulder of a raised portion of the elongate linkage traveling through the check body. Such overcoming force may be applied to move the passive check member into and out of the detent by deliberately moving the door by hand to the open position or closed position, as the case may be, or by a sufficiently strong breeze or the like acting on the door. Such passive door check means is operative without manipulation of an actuator or the like. Thus, in certain exemplary embodiments of this type, the passive door check means is always operative to hold the door in an open position against moderate closing forces and the selectable door check disclosed above, comprising a check lock member and remote actuator, can be employed at the user's option to positively lock the door in an open position against stronger closing forces by engagement of the check lock member to the elongate linkage. Other suitable designs for the passive door check will be apparent to those of ordinary skill in the art given the benefit of this disclosure.

In accordance with another aspect, a door assembly comprises, in combination, a door frame defining a door opening, a door pivotably mounted in the door opening for movement about an axis from a closed position to an open position, and a door check assembly as disclosed above. The door check assembly is connected to the door frame and to the door, such that opening and closing of the door involves the elongate linkage traveling through the guide block and through the check body if any.

From the foregoing disclosure and the following more detailed description of various preferred embodiments it will be apparent to those skilled in the art that the present invention provides a significant advance in the technology and art of door checks. In certain exemplary embodiments it is significant that the check-lock actuator can be positioned remotely from the check-lock member. For example, the check-lock member can be housed in a guide block proximate the pivot axis of the door, while the slide switch or other check-lock actuator can be positioned at the opposite part of the door, e.g., in the narrow edge face of the door near the main door latch. In this way, the check-lock actuator is convenient for use and does not require exposing the fingers or hands of the operator to potential risk of pinching at the pivot axis edge of the door. It is also advantageous that at least certain exemplary embodiments of the disclosed door checks are suitable for use in doors with thin cross sections. Additional features and advantages of various preferred embodiments will be better understood in view of the detailed description provided below.

### BRIEF DESCRIPTION OF THE DRAWINGS

FIG. 1 is an elevation view of a door for a motor vehicle, viewed from the inside and comprising a door check assembly in accordance with one embodiment of the present disclosure.

FIG. 2 is an elevation view of the hinge side of the door of FIG. 1, the narrow side surface of the door at its hinge(s).

FIG. 3 is an elevation view of the latch side of the door of FIG. 1, the narrow side surface of the door at its latch and, in the exemplary illustrated embodiment, the side where the check-lock actuator is located for convenient operation when the door is open.

FIG. 4 is an elevation view, partially broken away, of selected components of the door check assembly of the door of FIG. 1.

FIG. 5 is an elevation view, partially broken away, of the cable assembly of the door check assembly of the door of FIG. 1.

FIG. 6 is a perspective view of the guide block of the door check assembly of the door of FIG. 1.

FIG. 7 is an elevation view, partially in phantom, of the guide block of the door check assembly of the door of FIG. 1.

FIG. 8 is a perspective view of the slide bar assembly of the door check assembly of the door of FIG. 1.

FIG. 9 is an elevation view of the slide bar assembly of the door check assembly of the door of FIG. 1.

FIG. 10 is a plan view of the slide bar assembly of the door check assembly of the door of FIG. 1.

FIG. 11 is a schematic view of the lock bezel (shown in horizontal orientation rather than its in-assembly vertical orientation) of the door check assembly of the door of FIG. 1, through which, in assembly, a hand-operable actuator switch or button extends to set and release the door check.

FIG. 12 is an end view of the lock bezel of the door check assembly of the door of FIG. 1.

FIG. 13 is a side view of the lock bezel of the door check assembly of the door of FIG. 1.

It should be understood that the appended drawings are not necessarily to scale, presenting a somewhat simplified representation of various preferred features illustrative of the basic principles of the invention. The specific design features of a door check as disclosed here, including, for example, specific dimensions of the spring, the diameter of the rollers, and the length of the second link, will be determined in part by the particular intended application and use environment. Certain features of the illustrated embodiments have been enlarged or distorted relative to others to facilitate visualization and clear understanding. In particular, thin features may be thickened, for example, for clarity of illustration. All references to direction and position, unless otherwise indicated, refer to the orientation of the door check as illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the door check assemblies disclosed here and for the door assemblies incorporating them. The following detailed discussion of various alternative and preferred features and embodiments will illustrate the general principles of the invention with reference to a door check assembly in a recreational vehicle door. Other embodiments suitable for other applications, such as door check assemblies for automobiles and trucks, buildings, etc. will be apparent to those skilled in the art given the benefit of this disclosure.

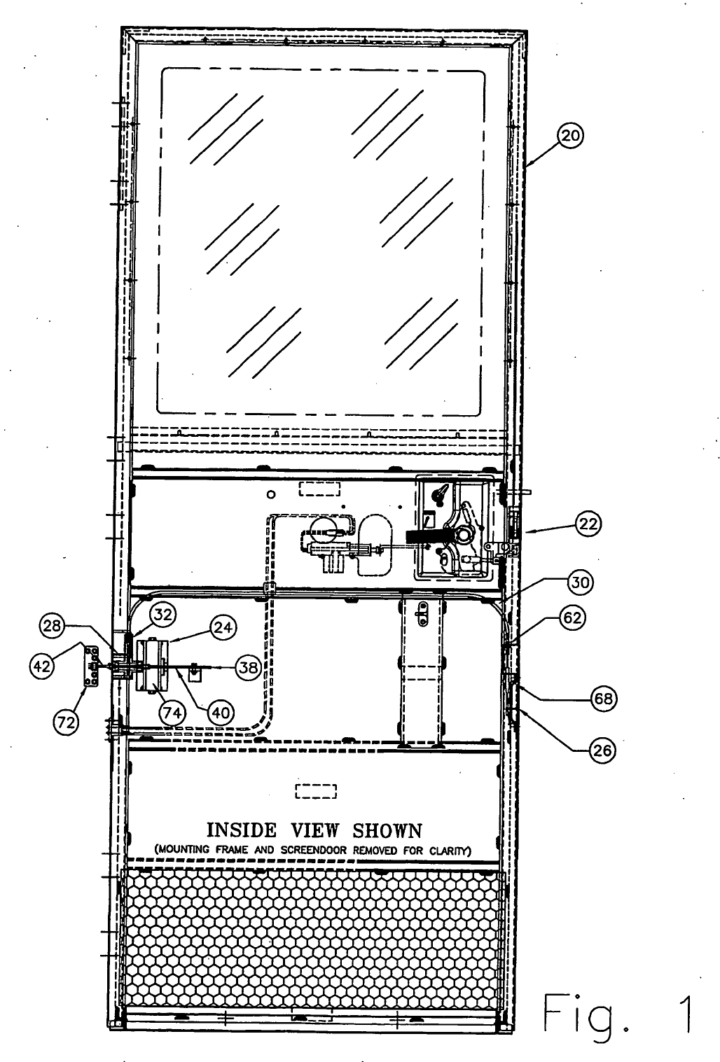

In certain exemplary embodiments of the door assemblies disclosed here, a door check assembly has at least a main link, typically an elongate rod, bar or plate, and a check body mounted to (e.g., in or on) the door. The main link typically is connected to the door jamb at the hinged side of the door (the left side of the door as viewed in FIG. 1) rather than at the handle side (the right side as viewed in FIG. 1), either directly or via one or more additional links pivot pinned or otherwise connected to the main link for articulated motion. As taught in U.S. Pat. No. 6,237,190, a check body or door check body can be provided as a guide and mounting feature for the main link. The check body can be formed as an inner body and an outer body or have other suitable construction. A stop can be provided to limit travel range, e.g., comprising a bumper supported by a backer plate or other mounting arrangement and a stop pin carried by the main link or by a secondary link. When the door check is at one end of its travel range (e.g., when the door is fully open), the check body abuts against the bumper. A shoulder bolt or the like mounted on a screw guidance bracket attached to the door can extend into a guidance slot in the main link to restrict the main link to linear motion with respect to the bolt as the main link moves back and forth (with movement of the door between open and closed positions) through the check body. Thus, the door can be cycled with the door check assembly over a travel range from a closed position to an intermediate open position, to a full open position. As the door pivots over the travel range, the check body moves with the door and the main link slidably moves through the check body.

The check body pivots with the door about the primary pivot axis established by the door's mounting hinges. A second link can pivot about a second axis at its pivot pin connection to the main link. To account for the difference between the primary pivot axis and the second axis, the main link translates through the door check body. This design is especially advantageous for doors having relatively thin cross section, i.e., thin doors, as a component of the motion is converted to translational motion of the main link. This eliminates the need to cut a large hole in the door for the link to pivot, a hole that may produce noise and weather or wind sealing difficulties.

The check body in certain exemplary embodiments mounts one or more biasing members, e.g., springs, to bias one or more rollers or the like to act against a door-hold ridge, such as a bump, protrusion or the like, on the main link to establish a soft door-holding position, i.e., a position readily overcome by further gentle pushing on the door or by a moderate breeze, etc. Thus, for example, an inner body of the door check body can receive a pair of springs or other biasing members, each sandwiched between a spring receiving plate and a roller housing. Each roller housing receives or holds a roller which rolls or slides over the surface of the main link. Adjustment screws received by the inner housing contact corresponding spring receiving plates. When the screws are tightened, the springs are compressed and pressure is increased between the rollers and the main link. This allows an assembler to fine tune the roller pressure to account for tolerance variations in the components of the door and the door check. The aforesaid door-hold ridge of the main link preferably has ramped shoulders or is otherwise faired, such that the rollers roll up and over the ridge to a flat or well portion of the main link as the door and check body move toward the full open position. When the rollers move to the well, a sufficiently large amount of force is required to overcome the force of the springs and climb back over the ridge, that the door is checked or held in a hold-open position against light to moderate door closing forces. Thus, small movements of the door, whether caused by wind or uncontrolled motion, etc., are not sufficient to move the door back to the closed position. The hold-open position extends between the well and the stop bumper.

To hold the door more securely against closure forces, the door check assemblies disclosed here provide a check-lock feature. The check lock feature in certain exemplary embodiments comprises a check-lock member mounted in a guide block which is itself mounted to the door, e.g., mounted in or on the door. The check-lock member is moveable by operation of an actuator, e.g., a finger-operable or hand-operable lever or other switch or the like, such as a lever mounted to the door, e.g., at a convenient location. As noted above, the actuator can also be electric and also can be pneumatic and/or other types of actuator devices. In certain exemplary embodiments in which the door check assembly is at the hinge side of the door (e.g., the left side as viewed in FIG. 1), the check-lock actuator is mounted remotely from the guide block, that is, at a location requiring connection via a flexible or multi-component actuator linkage or the like, wherein the check-lock actuator is operative via the linkage to move the check-lock member between the locking position and the unlocking position. In certain exemplary embodiments a suitable remote location is the door-handle side of the door (the right-side of the door as viewed in FIG. 1). In certain exemplary embodiments the actuator is in the narrow surface of the door (referred to in some cases as the edge of the door) at the door handle side of the door. Alternatively, the actuator can be in the main front or back surface of the door or other location. By operation of the actuator, the check lock member is moveable between:
a locking position (meaning a position relative to the guide block or other controllable condition of the locking member) in which it forms a positive locking engagement with the main link or other component of the elongate linkage, and
an unlocking position.

In the locking position the check-lock member's engagement of the main link prevents travel of the elongate linkage relative to the check body. In certain exemplary embodiments, therefore, in its locking position the check-lock member prevents movement of the main link through the check body even against strong closure forces. In its unlock position it does not prevent travel of the elongate linkage through the check body.

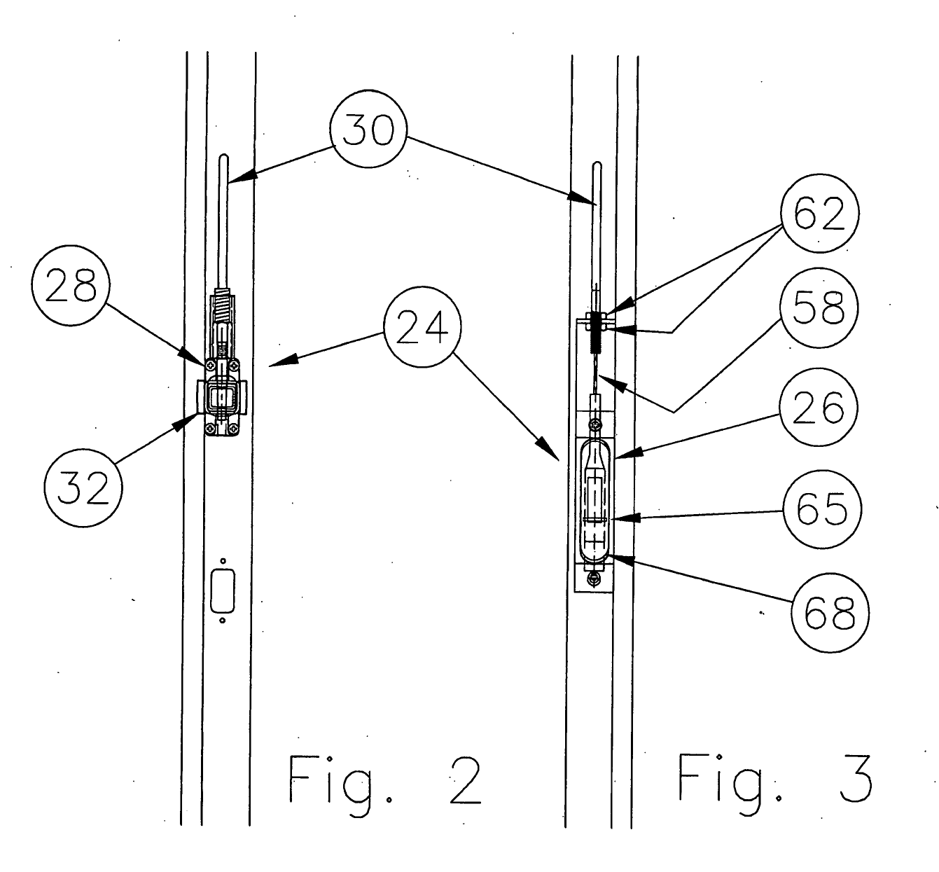

An exemplary embodiment is further described with reference to the drawings. A door assembly 20 is seen in FIG. 1, which is suitable for use in a recreational vehicle. FIG. 1 is an inside view of door 20, with a typical door latch assembly 22 and a door check assembly 24 in accordance with the present disclosure. The mounting frame and door screen are removed from door 20 for clarity. FIG. 2 is a view of the left side edge of door 20 (as viewed in FIG. 1) in the area of the guide block assembly 28 of the door check assembly 24. FIG. 3 is a view of the right side edge of door 20 in the area of the hand-operable door check actuator 26 of the door check assembly 24. An elongate flexible cable 30, such as a Bowden cable or other suitable linkage, is mounted to the door and interconnects hand-operable door check actuator 26 with guide block assembly 28. Thus, by operation of door check actuator 26 the door check can be set and released by hand. More specifically, as made clearer by the following description, operation of the actuator to release the door check causes the cable to retract a spring-loaded check-pin or other check-lock member mounted in the guide block assembly from a corresponding pin hole or other suitable engagement feature in the slide bar or other component of the elongate linkage of the door check assembly. Optionally, the actuator has a detent or other feature to hold the check-lock member in the unlock position. Alternative and additional suitable actuator features and designs will be apparent to those skilled in the art in view of this description.

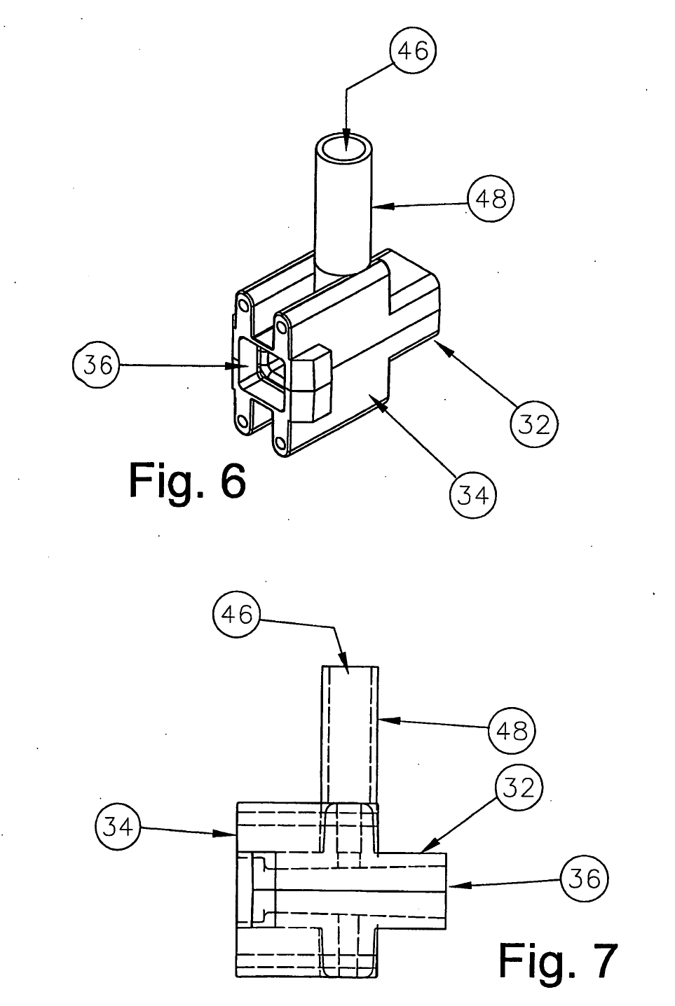

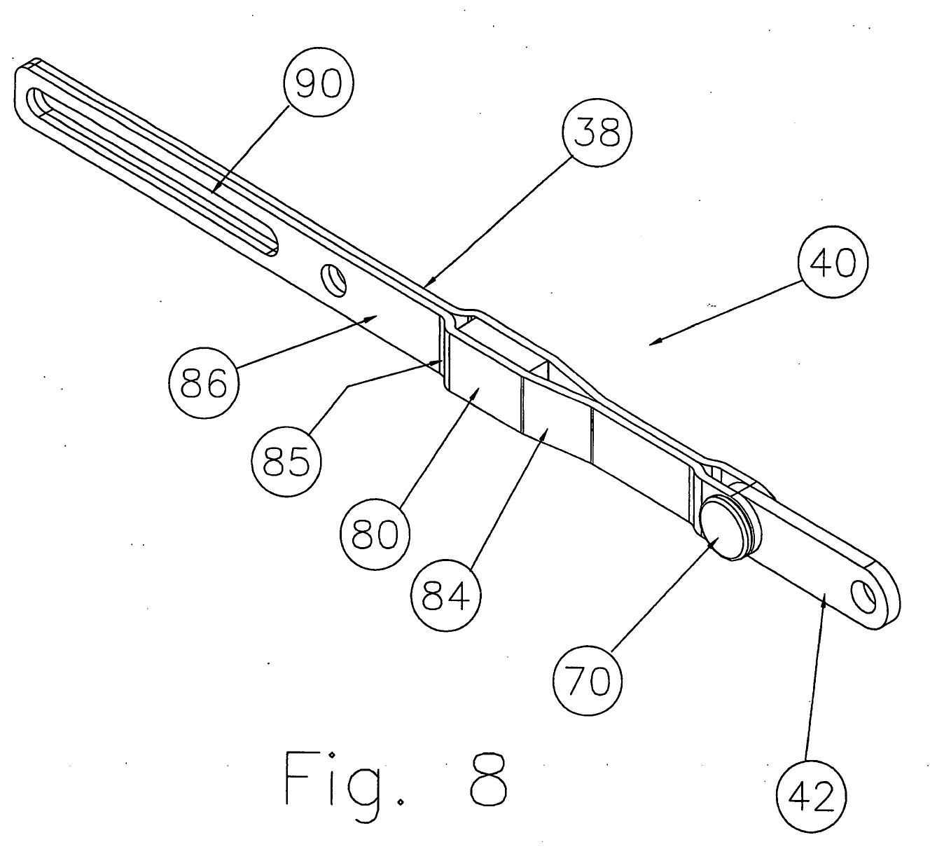

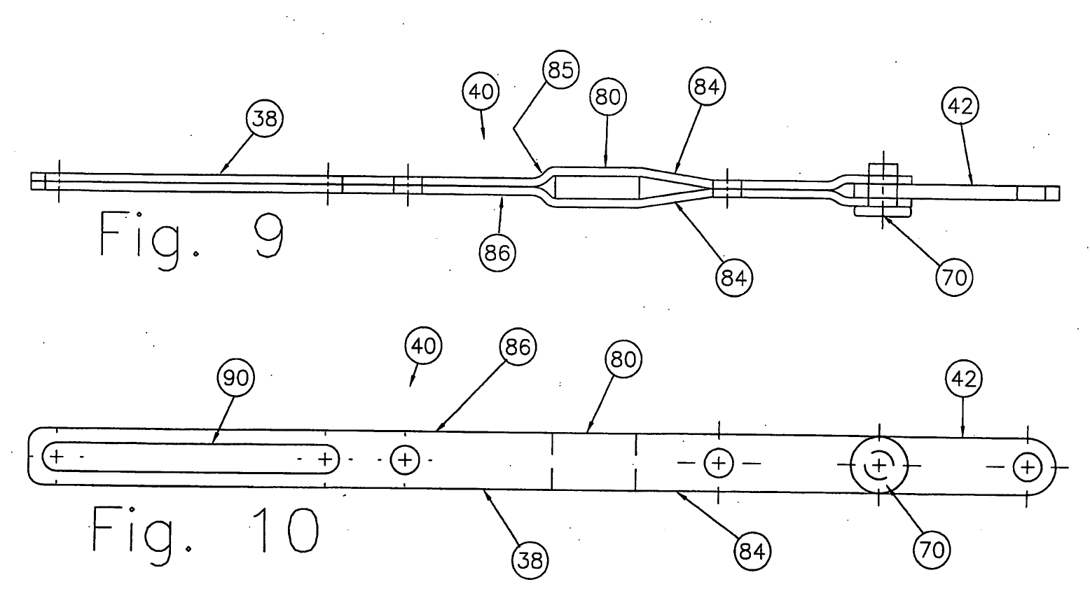

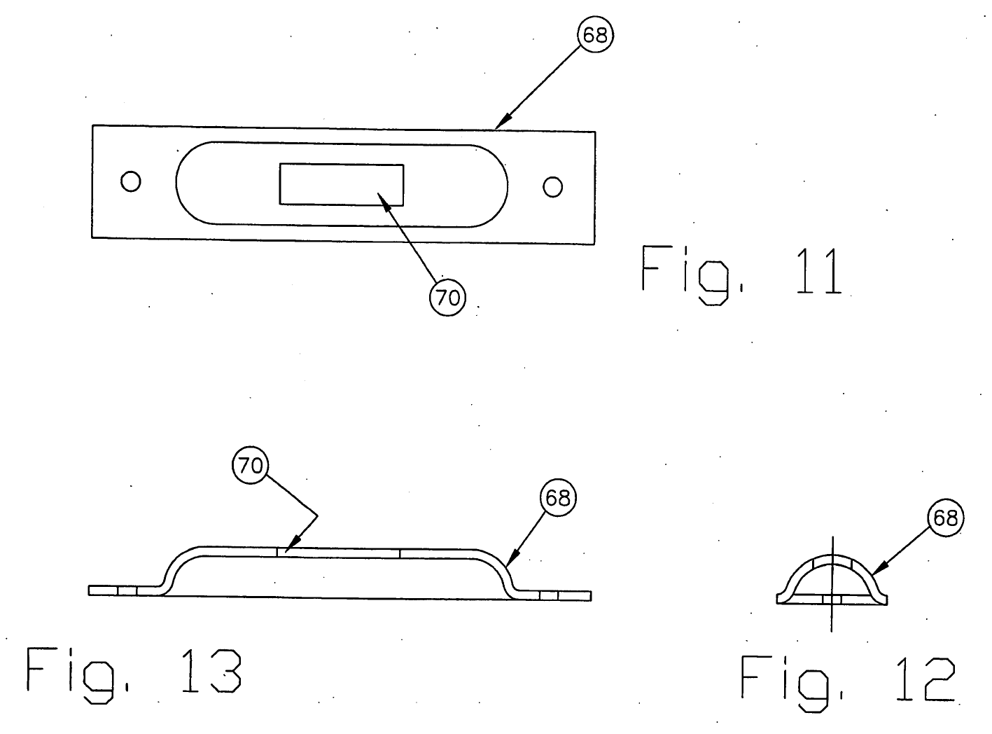

Guide block assembly 28 comprises guide block 32 mounted to the door. As best seen and FIGS. 6 and 7, guide block 32 of the illustrated embodiment as a main body portion 34 with a horizontal through-hole 36 to slidingly receive slide bar 38 of the elongate linkage 40 of the door check assembly. Elongate linkage 40 of the illustrated embodiment further comprises a secondary link 42, as seen in FIGS. 8-10, for articulation. A spring 44 or other biasing member is mounted in a vertically extending path 46 in a pin-holding chamber 48 of the guide block. A threaded terminal 64 of cable 30 connects to the check pin 52 and snub end coupling 54 is fitted to pin-holding chamber 48. Cable 30 includes conduit 56 and strand 58 within conduit 56. At the door check actuator end, cable 30 comprises a threaded conduit fitting 60 and a pair of jam nuts 62 for adjustably mounting the cable to a flange or other bracket or the like of the door. In the illustrated embodiment, a mounting bracket 66 is mounted to the door to provide structure for the door check actuator, and bezel 68 having a lever access hole 70 is mounted in the door surface for aesthetic and/or structural purposes. A radiused hex plug 50 attaches to a slide-bar switch 65 or lever or other hand-operable (e.g., finger-operable) member of the door check actuator. Alternatively, terminal 64 may itself be accessible for hand or finger operation through bezel 68.

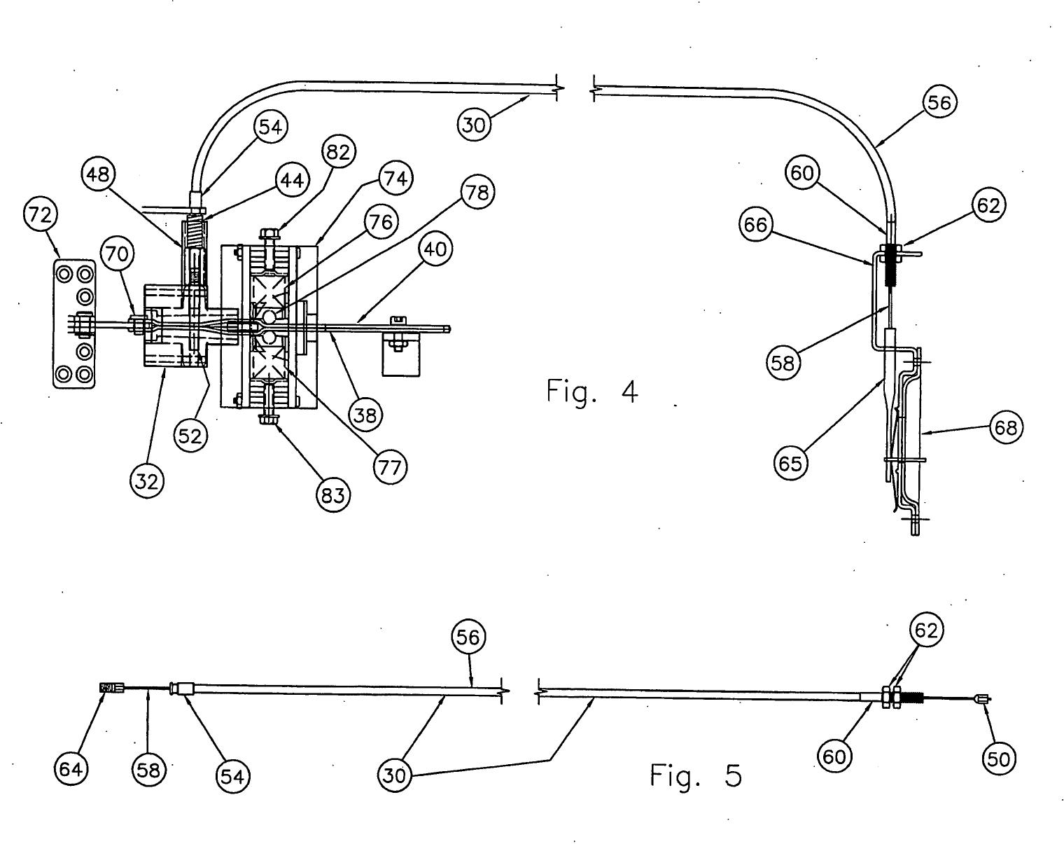

Secondary link 42 of the elongate linkage of the door check assembly is pivotably connected at its left end (as viewed in FIGS. 1 and 4) to a mounting bracket 72 or other suitable component of the door frame in which the door 20 is mounted. At its other in secondary link 42 is pivoted to main link 38 by pivot pin 70. Main link 38 is seen to be an elongate flat rod extending horizontally to the right from secondary link 42 through hole 36 in guide block 32 and then through door check body 74. Thus, in the illustrated embodiment the elongate linkage is operative to travel linearly, i.e. longitudinally through the guide block and check body between positions corresponding to various degrees of openness of a door incorporating the door check assembly.

Door check body 74 mounts a pair of springs 76, 77 or other biasing members to bias passive check member(s) into engagement with the elongate linkage. In the illustrated embodiment the passive check members are rollers 78, 79 which are operative to act against a door-hold ridge 80 on the main link 38 to establish a soft door-holding position, i.e., a position readily overcome by gentle pushing on the door or by a moderate breeze, etc. The springs 76, 77 are sandwiched between a spring receiving plate and a roller housing. Compression adjustment screws 82, 83 received by the door check body contact corresponding spring receiving plates. When the screws are tightened, the springs are compressed and pressure is increased between the rollers and the main link. The door-hold ridge 80 of the main link has ramped shoulders 84, 85 such that the rollers roll up and over the ridge to a flat or well portion 86 of the main link as the door and check body move toward the full open position. When the rollers move to the well, a sufficiently large amount of force is required to overcome the force of the springs and climb back over the ridge, that the door is checked or held in a hold-open position against light to moderate door closing forces. Thus, small movements of the door, whether caused by wind or uncontrolled motion, etc., are not sufficient to move the door back to the closed position. A shoulder bolt (not shown) mounted to the door extends into a guidance slot 90 in the main link to restrict the main link to linear motion with respect to the bolt as the main link moves back and forth (with movement of the door between open and closed positions) through the guide block and check body. Thus, the door can be cycled with the door check assembly over a travel range from a closed position to an intermediate open position, to a full open position. It can be fixed in the full open position by actuation of the door check assembly. Correspondingly, it can be released by releasing the door check assembly.

Optionally, multiple door check pin holes (or other engagement features) can be provided in the main link or other component of the elongate linkage to provide a corresponding number of positions at which the door can be positively fixed by actuation of the door check assembly. Thus, for example, multiple holes can be longitudinally spaced in the elongate linkage to receive the lock-pin in the locking position, corresponding to different open positions of a door assembly incorporating the door check assembly. In certain exemplary embodiments the check lock pin spring mounted in the guide block is operative to bias the lock-pin toward the locking position. In alternative embodiments, the lock pin spring mounted in the guide block is operative to bias the lock-pin toward the unlock position. Advantageously the slide-bar switch 65 in the door check actuator is operative to hold the lock-pin in the locking and unlock position against the bias of the lock-pin spring mounted in the guide block.

It will be apparent to those skilled in the art, given the benefit of this detailed description of certain exemplary embodiments, that numerous alternative designs will be suitable for any particular application. Further, it will be within the skill of those having ordinary skill in this area of technology to apply the principles disclosed here to design alternative embodiments of the door check assemblies disclosed here and doors incorporating such door check assemblies, for example, recreational vehicle screen doors and the like.

A door assembly incorporating a door check assembly in accordance with this disclosure typically comprises a door frame defining a door opening, a door pivotably mounted in the door opening for movement about a pivot axis between a closed position and an open position, and a door check assembly as described above. The door check assembly is connected between the door frame and the door.

From the foregoing disclosure and detailed description of certain preferred embodiments, it will be apparent that various modifications, additions and other alternative embodiments are possible without departing from the true scope and spirit of the invention. For example, it will be apparent to those skilled in the art, given the benefit of this disclosure, that multiple ramped surfaces and wells may be used to provide intermediate hold open positions for a door. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A door check assembly comprising, in combination:
a guide block;
an elongate linkage having a range of travel through the guide block between a first position and a second position corresponding to open and closed positions, respectively, of a door assembly;
a check-lock member mounted in the guide block for movement between
a locking position in which it forms a positive locking engagement of the elongate linkage operative to prevent travel of the elongate linkage through the check body from the first position to the second position, and
an unlocking position in which it does prevent travel of the elongate linkage through the check body from the first position to the second position;
a check-lock actuator; and
a linkage member connecting the check-lock actuator to the check-lock member, wherein the check-lock actuator is operative via the linkage member to move the check-lock member between the locking position and the unlocking position.

2. The door check assembly of claim 1 wherein the check-lock member is a lock-pin mounted for axial movement in the guide block, and wherein the lock-pin
in the locking position is in a hole in the elongate linkage, and
in the unlocking position is clear of the hole in the elongate link.

3. The door check assembly of claim 2 wherein the check-lock actuator is a slide-bar switch and the linkage member is a Bowden cable extending from the slide-bar switch to the guide block.

4. The door check assembly of claim 3 further comprising a lock-pin spring mounted in the guide block and operative to bias the lock-pin toward the locking position.

5. The door check assembly of claim 3 wherein the slide-bar switch is operative to hold the lock-pin in the unlocking position against the bias of the lock-pin spring mounted in the guide block.

6. The door check assembly of claim 2 wherein there are multiple holes longitudinally spaced in the elongate linkage to receive the lock-pin in the locking position, corresponding to different open positions of a door assembly incorporating the door check assembly.

7. The door check assembly of claim 1 further comprising a check body, the elongate linkage having a range of travel through the check body between the first position and the second position.

8. The door check assembly of claim 7 wherein the elongate linkage is operative to travel linearly through the guide block and check body between the first position and the second position.

9. The door check assembly of claim 7 further comprising at least one roller mounted in the check body and biased by a roller spring mounted in the check body into contact with the elongate linkage, wherein the elongate linkage has a detent portion and a raised portion, and wherein the roller is operative to roll over the raised portion to the detent portion as the elongate linkage travels through the check body toward the a first position, the roller in the detent portion being operative to provide resistance to the elongate linkage traveling through the check body to the a second position.

10. A door assembly comprising, in combination:
a door frame defining a door opening;
a door pivotably mounted in the door opening for movement about a pivot axis between a closed position and an open position; and
a door check assembly integral with the door frame, the door check assembly comprising, in combination:
a guide block;
an elongate linkage having a range of travel through the guide block between a first position and a second position corresponding to open and closed positions, respectively, of the door;
a check-lock member mounted in the guide block for movement between
a locking position in which it forms a positive locking engagement of the elongate linkage operative to prevent travel of the elongate linkage through the check body from the first position to the second position, and
an unlocking position in which it does prevent travel of the elongate linkage through the check body from the first position to the second position;
a check-lock actuator; and
a linkage member connecting the check-lock actuator to the check-lock member, wherein the check-lock actuator is operative via the linkage member to move the check-lock member between the locking position and the unlocking position.

11. The door assembly of claim 10 further comprising:
a check body, the elongate linkage having a range of travel through the check body corresponding to the range of travel of the elongate linkage between the first position and the second position; and
a passive check member mounted in the check body.

12. The door assembly of claim 11 further comprising a biasing member mounted in the check body and operative to bias the passive check member into contact with the elongate linkage in the check body.

13. The door assembly of claim 12 wherein the elongate linkage forms a detent to receive the passive check member.

14. The door assembly of claim 10 wherein the check-lock actuator is positioned in the door remote from the check-lock member.

15. The door assembly of claim 10 wherein
the door has a pivot side proximate the pivot axis and a latch side opposite the pivot side,
the guide block is mounted proximate the pivot axis side of the door, and
the check-lock actuator is positioned at the latch side of the door.
